(19) United States
(12) Patent Application Publication
(10) Pub. No.: US 2005/0045798 A1
(43) Pub. Date: Mar. 3, 2005

(54) Frame structure of an electrostatic precipitator

(76) Inventor: Ping Huang, Tainan Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/653,117

(22) Filed: Sep. 3, 2003

(51) Int. Cl. F16M 1/00

(52) U.S. Cl. 248/676

(57) ABSTRACT

An electrostatic precipitator includes insertion rods, and first and second metallic boards, which are respectively provided for positive and negative charges to be deposited on, and equidistantly positioned one over another with the first boards being only adjacent to second boards; each board has first holes, second holes smaller than the first holes, and engaging teeth projecting inwards from edges of the second holes; the first holes of the first boards are aligned with corresponding second holes of the second boards while the second holes of the first boards are aligned with corresponding first holes of the second boards; the insertion rods are inserted through the holes from an uppermost one to a lowermost one of the boards; the insertion rods are away from edges of the first holes, and engage the engaging teeth so as to secure the boards in position.

### BACKGROUND OF THE INVENTION

1. Field of the Invention

The present invention relates to a frame of an electrostatic precipitator, more particularly one, which is relatively simple in the structure, cheaper to manufacture, and fast and easy to assemble.

2. Brief Description of the Prior Art

Referring to FIGS. 6, and 7, a conventional frame of electrostatic precipitators consists of upper and lower aluminum boards 45, 46, long metallic boards 41 equidistantly spaced apart between the aluminum boards 45, 46, short metallic boards 42, which are each positioned between respective two long metallic boards 41 and equidistantly spaced apart, and metallic rods 43, 44 joined to the aluminum boards 45, 46 at two ends, and inserted through the metallic boards 41, 42 for supporting the metallic boards 41, 42 in position.

The long metallic boards 41 are provided for positive charges to be deposited on. Each long metallic board 41 is formed with several big through holes 411, and small through holes (not numbered) smaller than the big ones 411. The short metallic boards 42 are provided for negative charges to be deposited on. Each short metallic board 42 is formed with big through holes 421, and small through holes (not numbered) smaller than the big ones 421. The short boards 42 are positioned such that the big through holes 421 thereof are aligned with corresponding small through holes of the long boards 41, and the small through holes thereof are aligned with corresponding big through holes 411 of the long boards 41.

The metallic rods 43 are inserted through respective ones of the small holes of the long boards 41 so that they are also inserted through the corresponding big holes 421 of the short boards 42; thus, the metallic rods 43 are apart from the edges of the big holes 421 of the short boards 42, and tightly contact the edges of the small holes of the long boards 41, and in turns, electricity can travel through the long boards 41 via the metallic rods 43 when the electrostatic precipitator is powered. The metallic rods 44 are inserted through respective ones of the big holes 411 of the long boards 41 so that they are also inserted through the corresponding small holes of the short boards 42; thus, the metallic rods 44 are apart from the edges of the big holes 411 of the long boards 41, and tightly contact the edges of the small holes of the short boards 42, and in turns, electricity can travel through the short boards 42 via metallic rods 44 when the electrostatic precipitator is powered.

Sleeves 431 are positioned around the metallic rods 43, and inserted through the big holes 421 of the short boards 42 such that they are positioned between adjacent long boards 41, and distance between the long boards 41 is prevented from changing by means of the sleeves 431. Each metallic rod 43 is joined to insulating sleeves 451, 461 at two end portions thereof, which insulating sleeves 451, 461 are inserted in corresponding ones of holes formed on the upper and the lower aluminum boards 45, 46. And, nuts 452, 462 are coupled to upper and lower ends of each metallic rod 43. And, sleeves 441 are positioned around the metallic rods 44, and inserted through the big holes 411 of the long boards 41 such that they are positioned between adjacent short boards 42, and distance between the short boards 42 is prevented from changing by means of the sleeves 441. Each metallic rod 44 is joined to insulating sleeves at two end portions thereof, which insulating sleeves are inserted in corresponding ones of holes formed on the upper and the lower aluminum boards 45, 46. And, nuts are coupled to upper and lower ends of each metallic rod 44.

Thus, positive charges can be deposited on the long metallic boards 41 via the metallic rods 43, and negative charges on the short ones 42 via the metallic rods 44 when the electrostatic precipitator is powered. When dust in the air is made to have positive charges thereon by means of high voltage electricity, and passed through the electrostatic precipitator, the dust will be attracted to the short metallic boards 42, and in turns, air is cleaned.

However, in order to hold and space the metallic boards 41, 42 in position, metallic rods 43, 44 have to be used together with insulating sleeves 451, 461. In other words, two different forms of parts have to be used to constitute the supporting and spacing member for the metallic boards 41, 42 of the above electrostatic precipitator. Consequently, the electrostatic precipitator is complicated in the structure and relatively expensive to manufacture, and takes much time and labor to assemble.

### SUMMARY OF THE INVENTION

It is a main object of the present invention to provide a frame of electrostatic precipitator to overcome the above disadvantages.

The frame of the present invention includes insertion rods, and first, and second metallic boards, which are respectively provided for positive, and negative charges to be deposited on, and equidistantly positioned one over another with the first boards being between respective two of the second boards. Each of the metallic board has first holes, second holes having a smaller diameter than the first holes, and engaging teeth projecting inwards from edges of the second holes. The first holes of the first boards are aligned with corresponding second holes of the second boards while the second holes of the first boards are aligned with corresponding first holes of the second boards. The insertion rods are each inserted through corresponding first and second holes from an uppermost one to a lowermost one of the boards; the insertion rods are away from edges of the first holes, and engage the sharp ends of the engaging teeth while causing the engaging teeth to bend towards a direction in which they are inserted through the metallic boards; thus, the metallic boards are secured in position by means of the insertion rods.

### BRIEF DESCRIPTION OF THE DRAWINGS

This invention will be better understood by referring to the accompanying drawings, wherein:

FIG. 1 is an exploded perspective view of the electrostatic precipitator frame according to the present invention,

FIG. 2 is a partial perspective view of a metallic board of the electrostatic precipitator according to the present invention,

FIG. 3 is a vertical cross-sectional view of the electrostatic precipitator frame of the present invention,

FIG. 4 is a partial vertical section of the electrostatic precipitator frame according to the present invention,

FIG. 5 is a perspective view of the electrostatic precipitator frame according to the present invention,

FIG. 6 is a side view of the conventional electrostatic precipitator frame as described in the Background, and

FIG. 7 is a partial vertical section of the conventional electrostatic precipitator frame.

### DETAILED DESCRIPTION OF THE PREFERRED EMBODIMENTS

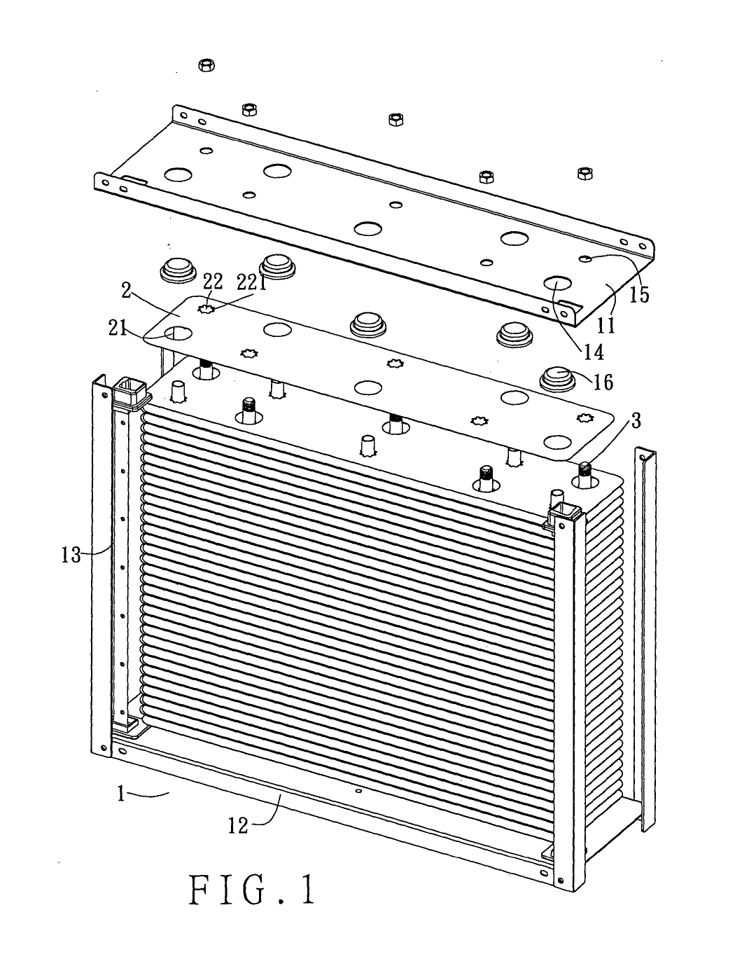

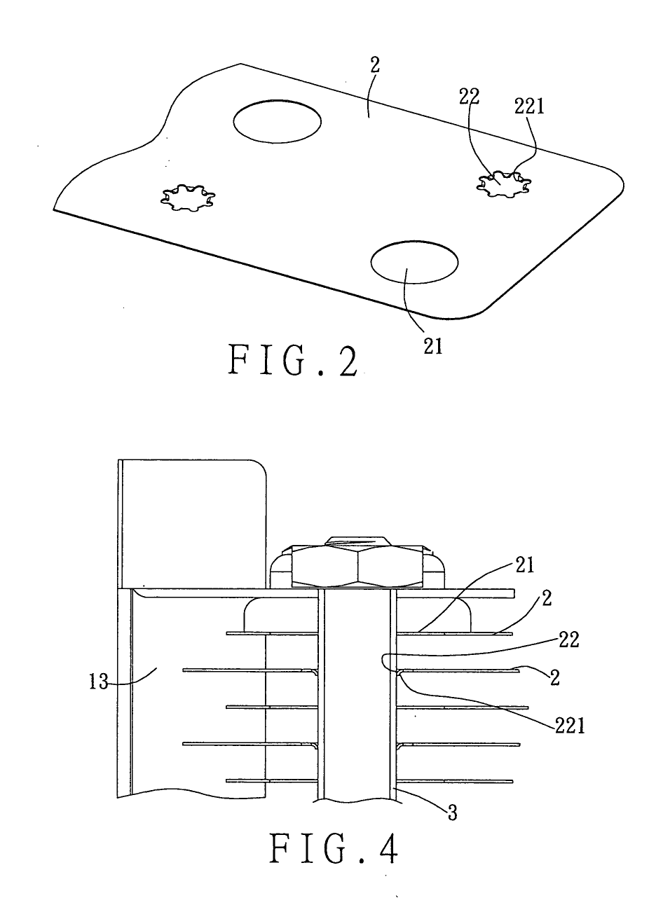

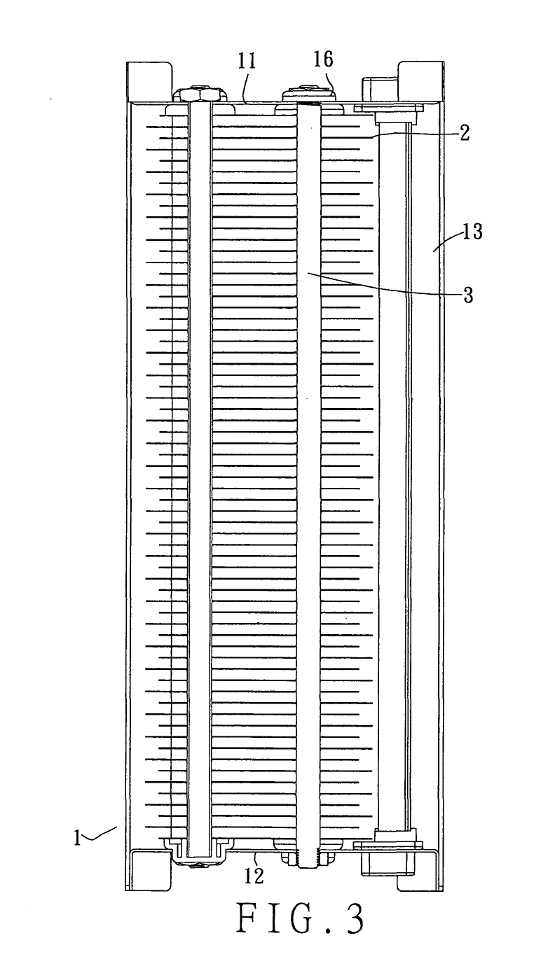

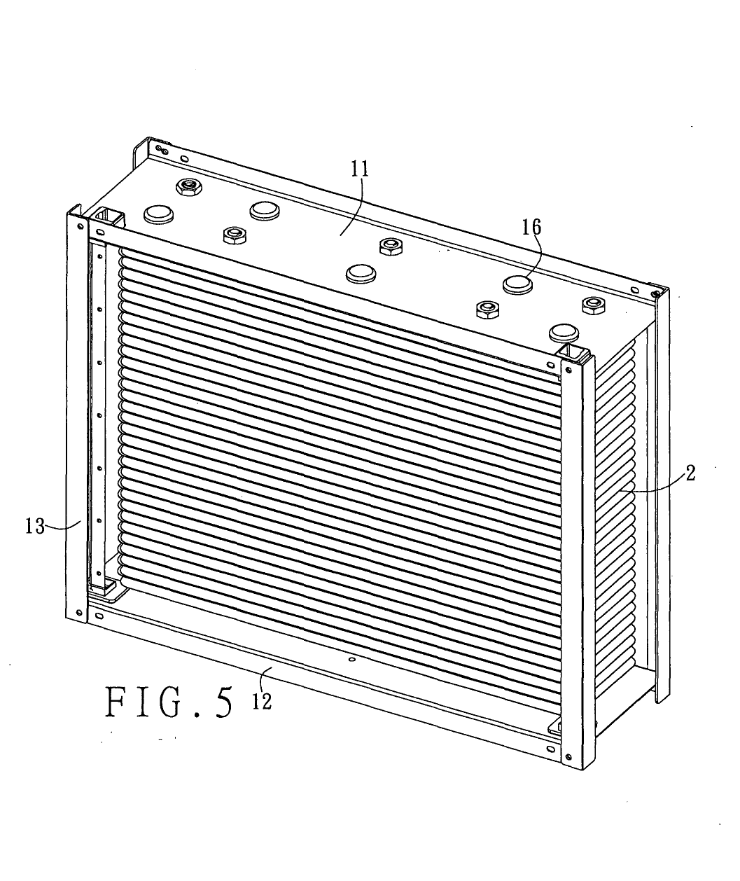

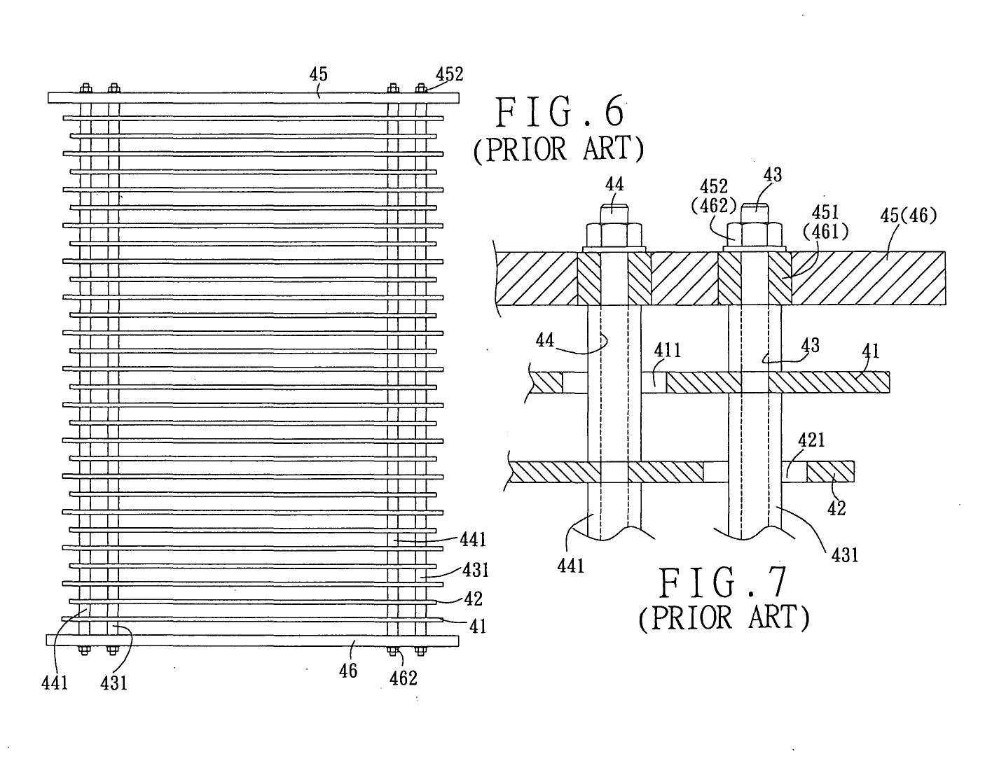

Referring to FIGS. 1 and 2, a preferred embodiment of an electrostatic precipitator frame 1 in the present invention includes an upper board 11, a lower board 12, support rod parts 13, several metallic boards 2, and straight metallic insertion rods 3.

The support rod parts 13 are coupled to edges of the upper board 11 at upper ends, and edges of the lower board 12 at lower ends thereof. Each of the boards 11 and 12 has through holes 14, and through holes 15, which are smaller than the through holes 14.

Each of the metallic boards 2 has holes 21, locating holes 22, and engaging teeth 221 projecting inwards from edges of the locating holes 22, as shown in FIG. 2; the holes 21 have a larger diameter than the straight insertion rods 3; the engaging teeth 221 in each locating hole 22 are formed such that sharp ends thereof are spaced apart on a circle, of which the diameter is smaller than the diameter of the holes 21, and is larger than the outer diameter of the straight insertion rods 3.

The metallic boards 2 are grouped into first boards for positive charges to be deposited on, and second boards for negative charges to be deposited on. All of the metallic boards 2 are equidistantly positioned one over another between the upper and the lower boards 11, 12 with the first boards being only adjacent to second boards; in other words, the first boards 2 are positioned between respective two second boards 2. The holes 21 of the first metallic boards 2 are aligned with corresponding locating holes 22 of the second metallic boards 2, and the locating holes 22 of the first metallic boards 2 are aligned with corresponding holes 21 of the second metallic boards 2. And, the holes 21 of an uppermost and a lowermost ones of the metallic boards 2 oppose respective large through holes 14 of the boards 11 and 12 while the locating holes 22 of the uppermost and the lowermost metallic boards 2 oppose respective small through holes 15 of the boards 11 and 12.

The straight insertion rods 3 are inserted in respective ones of the holes 14, 15 of the upper and the lower boards 11, 12 at upper ends and lower ends thereof, and are inserted through the holes 21, 22 of the metallic boards 2 for securing the boards 2 in position; caps 16 are fitted to the large through holes 14 of the boards 11, 12, and coupled to both ends of the straight insertion rods 3. Thus, those of the straight insertion rods 3 that are inserted through the holes 21 of the first boards 2 engage the engaging teeth 221 of the second boards 2, and only contact the second boards 2 because the holes 21 have a larger diameter than the straight insertion rods 3 providing a space between the insertion rods 3 and edges of the holes 21, and the straight insertion rods 3 will cause the engaging teeth 221 to bend towards the direction in which they are inserted through the boards 2, and in turns, the engaging teeth 221 firmly engage the insertion rods 3.

And, those of the straight insertion rods 3 that are inserted through the holes 21 of the second boards 2 firmly engage the engaging teeth 221 of the first boards 2, and only contact the first boards 2 because the holes 21 have a larger diameter than the straight insertion rods 3, and provide a space between the insertion rods 3 and edges thereof. Consequently, electricity can travel through the boards 2 via respective ones of the straight insertion rods 3 when the electrostatic precipitator is powered.

In assembling the present electrostatic precipitator frame, the straight insertion rods 3 are inserted through the metallic boards 2 after the metallic boards 2 have been held equidistantly apart by means of a machine especially made for the assembly. Thus, the metallic boards 2 are equidistantly positioned.

From the above description, it can be easily understood that the electrostatic precipitator frame of the present invention has an advantage over the prior one as described in the Background because insulating sleeves are not needed for spacing the metallic boards 2 and holding the boards 2 in position in the present invention, and only the straight insertion rods 3 are needed. Consequently, the present electrostatic precipitator frame is simpler in the structure, cheaper to manufacture, and easier to assemble as compared with the conventional one.

1. An improvement on a frame structure of an electrostatic precipitator, comprising
an upper and a lower board;
a plurality of support rod parts coupled to edges of the upper board at upper ends, and edges of the lower board at lower ends thereof;
a plurality of first and second metallic boards for opposite charges to be deposited on, the metallic boards being positioned one over another with the first boards being between respective two second boards; each metallic board having first holes, and second holes thereon;
the first holes of the first metallic boards being aligned with corresponding second holes of the second metallic boards; the second holes of the first metallic boards being aligned with corresponding first holes of the second metallic boards;
each of the metallic boards having engaging teeth projecting inwards from edges of the second holes thereof; engaging teeth in each of the second holes being formed such that sharp ends thereof are spaced apart on a circle; and
a plurality of insertion rods for securing the metallic boards in position, the insertion rods being firmly joined to the upper and the lower boards at two ends thereof, and held in corresponding first and second holes of the metallic boards;
the insertion rods having a smaller diameter than the first holes of the metallic boards, and a larger diameter than the circle, on which the sharp edges of the engaging teeth are spaced apart, such that the insertion rods are away from edges of the first holes, and engage the sharp ends of the engaging teeth while causing the engaging teeth to bend towards a direction in which they are inserted through the metallic boards.
